(19) United States
(12) Patent Application Publication
(10) Pub. No.: US 2008/0072709 A1
(43) Pub. Date: Mar. 27, 2008

(54) Container top opener with directionally inclined gripping ribs

(76) Inventor: Walter C. Dye, Winchester, CA (US)

Correspondence Address: ERIC HANSCOM, 7395 PORTAGE WAY, CARLSBAD, CA, 92011, US

(21) Appl. No.: 11/523,934

(22) Filed: Sep. 21, 2006

(51) Int. Cl. B67B 7/44; B67B 7/18; B67B 7/14

(52) U.S. Cl. 81/3.09; 81/3.4

(57) ABSTRACT

This invention is directed toward a container top opener with a hand gripping portion and a concave container top gripping portion. The device has a series of tapered gripping ribs which allow the device to be used on a wide range of container top sizes. The gripping ribs are directionally inclined such that the tighter a user twists the device, the more securely the gripping ribs bite into the container top and assist the user in untightening and removing the container top.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of devices which can untighten and remove the tops to containers, and more specifically, to a container top opener with a hand gripping portion and a concave container top gripping portion. The device has a series of tapered gripping ribs which allow the device to be used on a wide range of container top sizes. The gripping ribs are directionally inclined such that the tighter a user twists the device, the better the gripping ribs bite into the container top and assist the user in untightening and removing the container top.

Containers with tops have been around for hundreds of years, and the prior art is full of devices invented with the specific purpose of untightening and removing a container top from a container. This invention is directed toward devices to remove the container tops of containers where the container top is screwed on, such as with the common water bottle. Since the container caps for such bottles are usually tightened by a machine rather than a human hand, container caps are frequently screwed on so tightly as to prevent difficulties to the average person trying to open them. The container caps also frequently have a security band which prevents the discrete opening and closing of a container. This security band makes it even more difficult to apply adequate pressure to untighten and remove a container cap. The second type of container for which this device is intended is a container where the user is required to press down upon the container cap and twist it simultaneously to untighten and remove the cap. Because of the flat top of many such container caps, such as those traditionally found in medicine containers, it is difficult for a person to push down and simultaneously apply adequate pressure to the sides of the container to allow him or her to untighten and unscrew the container cap. Both types of containers often have miniscule gripping ribs on the sides of the container, making the turning of the container cap difficult when the cap is dry and nearly impossible when the container cap is wet.

Thus, there has existed for many decades a problem with providing a means by which a user of a container with a container cap can untighten and remove the container cap without the strength of a body builder.

The prior art has several examples of attempts to resolve this problem. There is a long line of patents which have some sort of vertical ribs which are intended to grip a container top and apply pressure to the container top from one or more sides, thereby making the user's job of twisting the container cap off easier. For example, U.S. Pat. No. D383,954 to Biunno, U.S. Pat. No. D261,854 to Nielsen, U.S. Pat. No. D281,051 to Nielsen, U.S. Pat. No. D 289,364 to Bass, U.S. Pat. No. D277,160 to Antone, U.S. Pat. No. D297,203 to Chouinard, U.S. Pat. No. D433,607 to Park, U.S. Pat. No. D442,449 to McQuillan, U.S. Pat. No. D458,097 to Guardia, U.S. Pat. No. D482,251 to Kelleghan, U.S. Pat. No. 3,919,901 to Braman, U.S. Pat. No. 4,415,865 to Brooks, U.S. Pat. No. 4,455,894 to Roberts, U.S. Pat. No. 4,911,038 to Ferrin, U.S. Pat. No. 4,967,622 to Phillips, U.S. Pat. No. 4,979,407 to Hernandez, U.S. Pat. No. 6,098,497 to Larose, U.S. Pat. No. 6,105,468 to Fohrman, U.S. Pat. No. 6,666,110 to Buettner, U.S. Pat. No. 3,812,741 to Heine, U.S. Pat. No. 4,723,465 to Hughes, and US Application No. 2005/0193867 A1 to Haynes all teach a substantially round ring, the inside of which has an array of vertical ribs which are intended to grip the edges of the container cap and make breaking any security seal between the container cap and the container easier, along with making untwisting the container cap from the container easier. While these devices may offer some improvement over the traditional hand-grip one can apply to a container top, they do not solve the problem of adapting to different sizes of container caps and they do not offer any additional grip capabilities should a user need to add pressure to his or her turning effort.

There are also several devices in the prior art which teach a tapered receptacle or cavity into which the container cap fits. These receptacles also have, in many cases, vertical ribs which can grip the sides of a container cap. Many of such devices, for example, U.S. Pat. No. D311,668 to Bryant and U.S. Pat. No. D447,923 to Taylor, are considerably more complex than the current invention and are not as as aesthetically pleasing as the current invention, thereby precluding themselves from being a container cap opener that can be easily carried along in a person's pocket, or left out on a more or less permanent display on a countertop or table. U.S. Pat. No. 3,225,714 to Gaskell also teaches a tapered dough-moulding machine, which has tapered sides and could conceivably be used to open a container cap if the device was shrunk down to about 1/10^{th} of its patented size, but this device, along with those designed to open container caps which have tapered sides, still do not solve the problem of how to add additional gripping abilities when the container cap in on tightly or one needs to break a security seal before opening the container.

Thus there has existed a long-felt need for a device that can be used to open a variety of container tops with different sizes, which may also have security seals, factory tightness which exceeds the strength of the average person, and/or tops which have to be pushed down concurrently with the rotational twisting by hand.

The current invention provides just such a solution by having one device which solves all of the aforementioned, long-felt needs. The invention is a small device, which can be kept easily on one's pocket, which has a concave container top gripping portion with a series of tapered gripping ribs which allow the device to be used on a wide range of container top sizes. The gripping ribs are directionally inclined such that the tighter a user twists the device, the better the gripping ribs bite into the container top and assist the user in untightening and removing the container top. The device has an attractive hand gripping portion which has finger grips or some other means of allowing a person using the device to easily grasp it and twist it. The device can be made out of metal, burnished, tinted, or coated with a variety of attractive finishes, or can be made out of hard plastic or some other material which is hard enough to bite into the plastic from which most container caps are manufactured.

### SUMMARY OF THE INVENTION

It is a principal object of the invention to provide an inexpensive, small, compact, attractive, and efficient device that can be used to open a variety of container tops.

Additional objects of the invention include:

That the device has gripping means on its upper surface and/or outer circumference that allow a person using the device to apply pressure in a twisting manner.

That the device has directionally inclined gripping ribs which are tapered out from the top of the concave hollow to the outward edge of the device, such that the harder a person twists the device, the stronger a grip between the device and the container top is established, as the directionally inclined gripping ribs “screw” onto the ribs of the container cap.

That the device can be made from metal, which can be burnished, tinted, or coated with a variety of attractive finishes, such that the device is attractive enough to leave out on a countertop, bar, or table.

That the device can be made out of hard plastic or some other material which is hard enough to bite into the plastic from which most container caps are manufactured.

That the device can be made inexpensively, such that it is appropriate to give away at events such as sporting events, or given away with an advertising logo emblazoned on its surface, or used as a promotional tool in some other way.

That the directionally inclined gripping ribs of the device are particularly well suited for removing container caps that have gotten wet and are otherwise very difficult to remove.

That the directionally inclined gripping ribs of the device are particularly well suite for removing container caps that have had their ribs or gripping surfaces worn away.

It is a final object of this invention that upon the basic device as outlined above can be attached or included a number of additional features, such as bottle cap openers, key chains and other tethers,

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a perspective view of the top and sides of the invention, showing the finger grips and the optional bottle cap opener.

FIG. 2 is a bottom perspective view of the device showing the directionally inclined gripping ribs.

FIG. 3 is a bottom view.

FIG. 4 is a top view.

FIG. 5 is a cross sectional view, showing the directionally inclined gripping ribs.

### DETAILED DESCRIPTION OF THE FIGURES

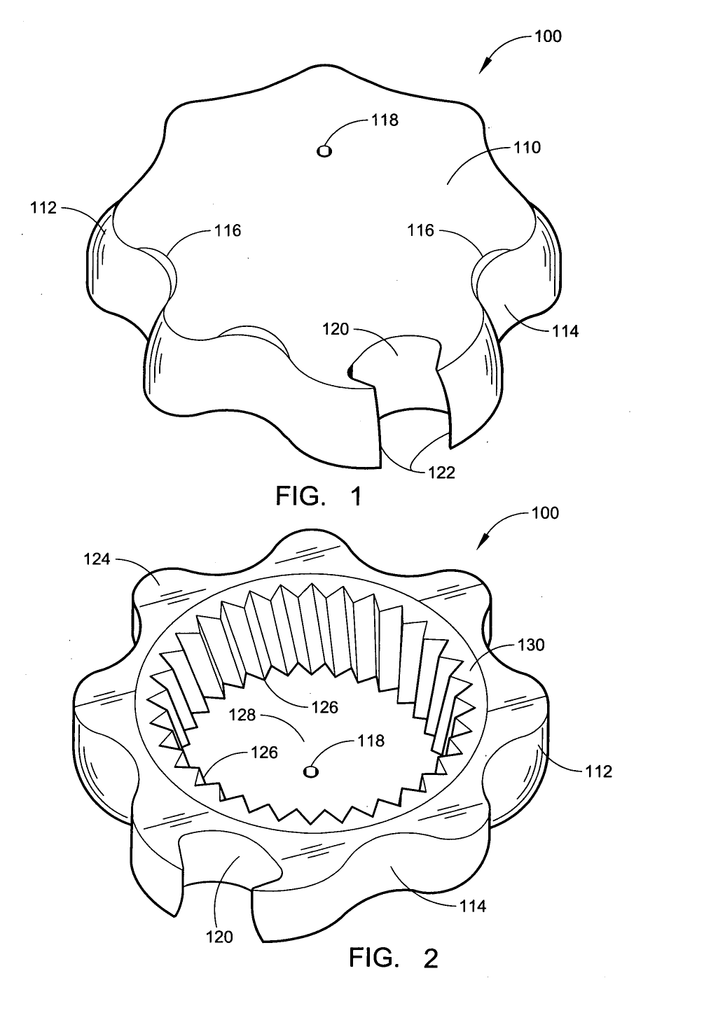

FIG. 1 is a perspective view of the top and sides of the invention, showing the finger grips and the optional bottle cap opener. The invention, generally indicated by reference number 100, comprises a top surface (110) in the general shape of a circle, a side surface (116) with alternating cavities (114) and projections (112), which create an attractive, scalloped look, which provides, conveniently, indentations approximately the same size as an average person's fingers, thereby giving the edge of the device a useful shape for a person trying to grip the device and apply pressure. The invention also has an optional top hole (118) and, in this iteration, a bottle cap opener with a bottle cap cavity (120) and two projecting cap openers (122). The optional hole allows a user of the invention to store it on a hook, nail, or other hanging device under a counter, on a bar, inside a cabinet, or in another place where it would be logical and convenient to store a device which can open container tops and bottle caps. To open a bottle with a bottle cap, the bottle cap is inserted into the bottle cap cavity (120) and the projecting cap openers (122) under the lip of the bottle cap is pulled against the lip, whereupon the device is rolled backwards and the bottle cap is leveraged off. The projecting cap opener (122) can also be used to open a can with a pull-tab, as the user can insert on of the two projecting cap openers (122) under the pull tab, then roll the device backwards to pull up on the pull-tab. The surface (110) in this figure is plain, without texture, but can, optionally, be made with a considerable variety of textures—some ornamental, some functional.

FIG. 2 is a bottom perspective view of the device showing the directionally inclined gripping ribs. The device has a bottom surface (124) which is flat, and connects the outer surface to the gripping section (130). The gripping section can be made as a part of the device, or it can be made from a separate material and inserted into a cavity built into the device. In either case, the preferred embodiment of this invention has directionally inclined gripping ribs (126) which are sharp projections slanted such that as a user of the invention twists the device about the container cap, the gripping ribs bite into the container cap, improving the grip, where the harder a user twists the device, the more solid a grip the device has on the container top. In a particularly preferred embodiment, the gripping ribs are not only directionally inclined, but also tapered out, such that the device can open a variety of sizes of container tops. The device also has a crown section (128) which is slightly rounded section lying directly above the container top when the device is in use.

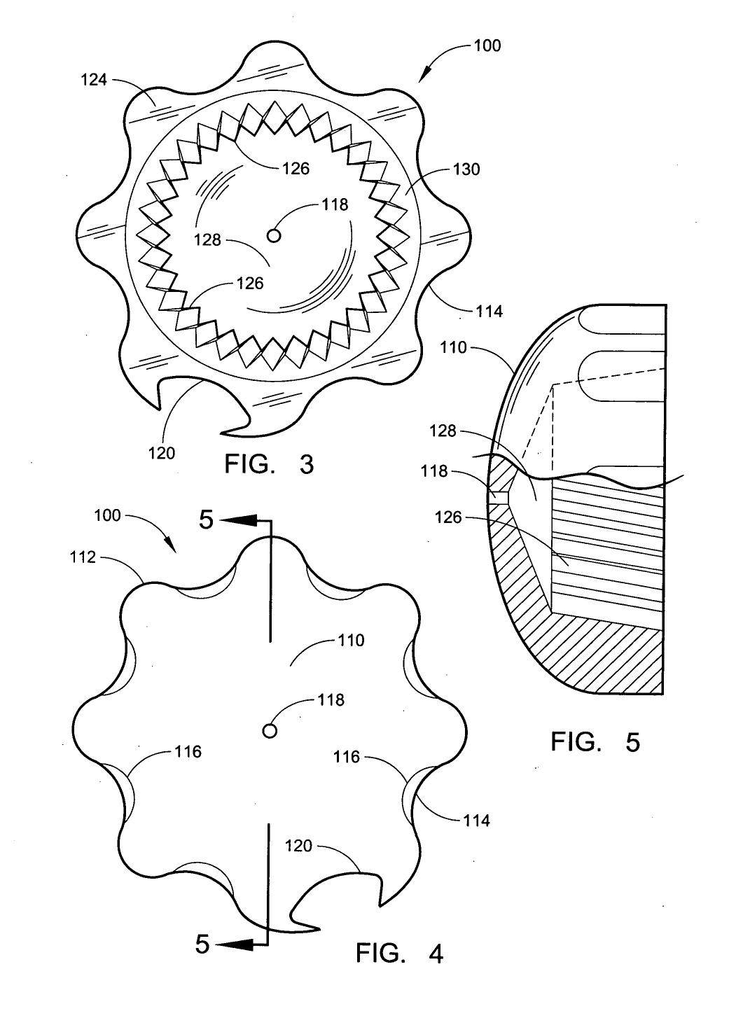

FIG. 3 is a bottom view of the device (100) showing the scalloped edges of the outer edge, created by the with alternating cavities (114) and projections (112). In this figure, the gripping ribs (126) are slightly tapered out, such that a variety of container caps can be opened by the device. It is also envisioned that a manufacturer of the device could design it larger, and with more of a taper to the gripping ribs, such that an even wider range of container top sizes can be opened by the same device. The tapered gripping ribs also allow a user of the device to use the device to open medicine containers and other child-proof containers which require a user to push down and turn at the same time. While such a design is theoretically easy to use, in practice, the sides of the container tops are often smooth or nearly smooth, and relatively small and thin, such that it is very hard to get a good grip on the sides of the container top while the user is pushing down simultaneously. Where the gripping ribs are both tapered and directionally inclined, the advantages of the devices are even greater, as the user needs only to push down on the top of the device and rotate his/her hand at the wrist, and the taper will allow the container cap to be gripped at an appropriate part of the gripping ribs, and by rotating the wrist, the directionally inclined gripping ribs will dig into the plastic container top and allow the user of the invention to use all of her or her arm and shoulder strength to open the container top.

FIG. 4 is a top view of the device in the iteration in which there is no texture on the top surface (110). Texture—either decorative or functional—can be added to the top surface to provide a more attractive device or to decrease the amount of strength a user has to apply to the device to untwist or unscrew a container top, as with adequate texture all a user has to do is lean down on the device and rotate his or her wrist, thereby twisting the device, which, in turn, twists the container top.

FIG. 5 is a cross sectional view, showing the directionally inclined gripping ribs (126). From this figure it can be seen how tapered, directionally inclined gripping ribs will allow a user of the device to place it on top of a container cap and pushed down until the gripping ribs contact the outer edge of the container cap. It can also be seen that the container cap can be in a certain range of diameters based on the diameter of the gripping cavity at the lower and upper extremes. Once the gripping ribs come into contact with the outer edge of the container top, the user merely has to either twist the device and/or push down and the gripping ribs will “screw” onto the container cap, such that the harder a user twists, or pushes down on the device, the more securely the device will grip the container top.

What I claim is:

1. A device for removing a container top from a container, comprising:
a top surface,
a side surface,
a bottom surface with a downwardly projecting opening recess formed in the center of the bottom surface,
a gripping section, where the gripping section is located within the downwardly projecting opening recess in the bottom surface,
and a plurality of gripping ribs within the gripping section, where the gripping ribs are directionally inclined,
where the gripping section is substantially circular in shape, and,
where, when the device is placed over a container cap of a container and pushed down upon the container cap, the plurality of gripping ribs frictionally adhere to a side of the container cap, so that when a user of the invention rotates the device over the container cap, the gripping ribs apply greater pressure, and, thereby, greater adhesion, to the sides of the container cap and the gripping ribs “screw” down, as the user applies greater pressure to the twisting action, and the untightening and removal of the container cap is facilitated by the greater adhesion of the gripping ribs to the sides of the container cap.

2. The device of claim 1, where the gripping ribs are tapered.

3. The device of claim 1, additionally comprising a device which is both a bottle cap opener and a beverage can pull-tab opener.

4. The device of claim 1, additionally comprising a key chain.

5. The device of claim 1, where the top surface is without texture.

6. The device of claim 1, where the top surface is textured.

7. The device of claim 1, additionally comprising a hole in the middle of the top surface which extends down through the device.

8. The device of claim 1, additionally comprising a gripping section, where the gripping section comprises a plurality of tapered, directionally inclined gripping ribs.

9. The device of claim 8, where the gripping section is a contiguous part of the device and manufactured from the same mold.

10. The device of claim 8, where the device additionally comprises a gripping section cavity and the gripping section is a separate unit which is inserted into the gripping section cavity and attached thereto.

11. The device of claim 10, where the device is made from plastic and the gripping section is made from metal.

12. The device of claim 1, where the device is made from plastic.

13. The device of claim 1, where the device is made from metal.

14. The device of claim 13, where the metal has been subjected to a treatment to enhance its appearance, where the treatment is selected from the group comprising: burnishing, polishing, tinting, texturing, and coating.

15. The device of claim 1, where the side surface is substantially round in shape.

16. The device of claim 15, where the side surface additionally comprises alternative cavities and projections, such that the perimeter of the device appears scalloped, where the cavities are approximately the size of a human finger.

17. A device for removing a container top from a container, comprising:
a top surface,
a side surface,
a bottom surface with a downwardly projecting opening recess formed in the center of the bottom surface,
a gripping section, where the gripping section is located within the downwardly projecting opening recess in the bottom surface,
and a plurality of gripping ribs within the gripping section, where the gripping ribs are directionally inclined and tapered,
where the gripping section is substantially circular in shape, and,
where, when the device is placed over a container cap of a container and pushed down upon the container cap, the plurality of gripping ribs frictionally adhere to a side of the container cap, so that when a user of the invention rotates the device over the container cap, the gripping ribs apply greater pressure, and, thereby, greater adhesion, to the sides of the container cap and the gripping ribs “screw” down, as the user applies greater pressure to the twisting action, and the untightening and removal of the container cap is facilitated by the greater adhesion of the gripping ribs to the sides of the container cap.

18. The device of claim 17, where the side surface additionally comprises alternative cavities and projections, such that the perimeter of the device appears scalloped, where the cavities are approximately the size of a human finger.

19. A method of opening a container top, comprising the steps of:
1) pick up a device for removing a container top from a container, the device comprising:
a top surface,
a side surface,
a bottom surface with a downwardly projecting opening recess formed in the center of the bottom surface,
a gripping section, where the gripping section is located within the downwardly projecting opening recess in the bottom surface,
and a plurality of gripping ribs within the gripping section, where the gripping ribs are directionally inclined,
where the gripping section is substantially circular in shape, and,
where, when the device is placed over a container cap of a container and pushed down upon the container cap, the plurality of gripping ribs frictionally adhere to a side of the container cap, so that when a user of the invention rotates the device over the container cap, the gripping ribs apply greater pressure, and, thereby, greater adhesion, to the sides of the container cap and the gripping ribs “screw” down, as the user applies greater pressure to the twisting action, and the untightening and removal of the container cap is facilitated by the greater adhesion of the gripping ribs to the sides of the container cap,
2) place device over a container cap, such that the container cap fits within the gripping section,
3) apply pressure in a downward manner on the device, such that the gripping ribs adhere to the sides of the container cap in a screw-like fashion,
4) apply rotational pressure to the device until the container cap is removed from the container,
5) grasp the bottom of the container cap with at least two digits of the user's hand,
6) apply rotational pressure in a direction the reverse of which was used to remove the container cap, until the container cap is removed from the device, and store the container cap until it is desired to put the container cap back on the container.

20. The method of claim 19, where, the device additionally comprises additionally comprises alternative cavities and projections, such that the perimeter of the device appears scalloped, where the cavities are approximately the size of a human finger.
